(19) United States
(12) Patent Application Publication
(10) Pub. No.: US 2022/0175180 A1
(43) Pub. Date: Jun. 9, 2022

(54) A COFFEE GRINDING DEVICE AND A COFFEE MACHINE HAVING SAID DEVICE

(71) Applicants: Altug ÜNAL, Nilüfer, Bursa (TR); MASTAS MAKINA KALIP SANAYI VE TICARET ANONIM SIRKETI, Nilüfer, Bursa (TR)

(72) Inventor: Altug ÜNAL, Nilüfer, Bursa (TR)

(21) Appl. No.: 17/442,751

(22) PCT Filed: Mar. 18, 2020
(86) PCT No.: PCT/TR2020/050217

§ 371 Date: Sep. 24, 2021

(30) Foreign Application Priority Data
Mar. 26, 2019 (TR) 2019/04491

(51) Int. Cl. A47J 31/42; A47J 42/40; A47J 42/46

(52) U.S. Cl. CPC A47J 31/42; A47J 42/46; A47J 42/40

(57) ABSTRACT

A coffee grinder having at least a flow channel that directs the ground coffee particles conveyed from the outlet of the grinder in order to transfer them to a container, and its inlet positioned right below the grinder outlet and connected to the grinder such that it can rotate according to the channel inlet axis that passes through the center of the inlet, and a motion control motor that successively moves the flow channel at the inlet axis in opposite radial directions in a suitable amount and frequency in order to prevent the sticking of the ground coffee particles located in the flow channel to the flow channel. A coffee machine having such a coffee grinder is also disclosed.

### TECHNICAL FIELD

The invention is related to a device that is used to prepare a beverage from powder formed ingredients.

The invention is particularly related to a particle carrier system that prevents the immobility or sticking of the particles onto the surface over which they are being carried and a Turkish coffee preparation device provided with said coffee grinder.

### PRIOR ART

Coffee is one of the most preferred hot beverages nowadays, and it is consumed after being prepared with several different brewing methods. Said different types of coffee are generally prepared from coffee beans that have been ground to have different particle sizes. One of the coffee types mentioned is Turkish coffee. In order for Turkish coffee to be prepared to have the desired consistency, the coffee beans need to be finely ground. 70 to 75% of the ground particles need to have a size, approximately between 75-125 microns.

Although it is crucial to have this ratio for the coffee to have the desired taste, it leads to a significant problem during the delivery of the coffee into the container in which it is to be cooked. When the coffee particles are ground to the size that is mentioned, they tend to stick to each other, or onto the surface over which they are being carried. The steam that is created during the cooking of the coffee increases such a trend.

The sticking and/or agglomeration of coffee during delivery may, not only clog the route that it is being carried through but the coffee particle remnants that are created may go stale after some time and this may affect the aroma of the coffee.

The solution that is tried to be provided regarding this issue has been disclosed in the document numbered EP3049771 (A1) via an arrangement for transporting flow of ground powder. The spring elements that have been connected to a container that has been provided conically provide vibration and they move the powder granules that are present inside the container. Similarly, a structure directed to regulating flow, by means of attaching vibration elements to a silo apparatus, has been described in the document numbered DE4120201 (A1).

In the document numbered US2016263539 (A1), a mechanism arranged for protein beverages has been disclosed. In the mechanism mentioned different types of protein powders can be selected to prepare a beverage. The beverage powder selected is moved by means of an oscillation motor in order to prevent agglomeration due to humidity or other similar factors.

In the document numbered US2016263539 (A1) another type of protein beverage preparation device has been disclosed. When the powder is mixed with a liquid in the system, the container containing the mixture is vibrated by means of a motor.

The oscillation motors used for ensuring regular flow, causes the mechanical components of the devices to be damaged in the medium and long term and the usage lives of the devices are reduced.

As a result, all of the problems mentioned above, have necessitated a novelty to be carried out in the related art.

### AIM OF THE INVENTION

The present invention aims to eliminate the problems mentioned above and to provide a novelty in the related art.

The main aim of the invention is to convey a coffee preparation device having a particle carriage system that prevents the immobility or sticking of particularly, the particles that are smaller than 150 microns, onto the surface over which they are being carried.

Another aim of the invention is to particularly prevent the sticking of coffee particles that accumulate around the dispensing opening and to ensure that the opening is kept clean.

Another aim of the invention is to eliminate the requirement for uncontrolled vibration and therefore to increase the usage lives of coffee preparation and grinding devices.

### BRIEF DESCRIPTION OF THE INVENTION

The present invention is related to a coffee grinder comprising a grinding mechanism that has at least a grinding outlet, for grinding coffee in order to reach all of the aims that shall be construed from the information given above and the detailed description below. Accordingly, the invention comprises at least a flow channel that directs the ground coffee particles conveyed from the outlet of the grinder in order to transfer them to a container, and its inlet positioned such that right below the grinder outlet and connected to the grinder such that it can rotate according to the channel inlet axis that passes through the center of said inlet, and a motion control motor that successively moves said flow channel at the inlet axis in opposite radial directions in a suitable amount and frequency in order to prevent the sticking of the ground coffee particles located in the flow channel, to said flow channel.

A preferred embodiment of the invention comprises a control unit in order to control at least one of the factors such as movement speed, frequency, acceleration and motion distance of said motion control motor.

A preferred embodiment of the invention comprises an input unit in order to determine at least one of the factors such as movement speed, frequency, acceleration and motion distance of said motion control motor.

In a preferred embodiment of the invention, said motion control motor is a servo motor.

In a preferred embodiment of the invention, said motion control motor is a stepper motor.

In a preferred embodiment of the invention, said motion control motor is a DC motor with an encoder.

A preferred embodiment of the invention comprises a flow channel gear provided to rotate according to the inlet axis, such that it is fixedly connected to the flow channel and a transfer element that transfers the rotation motion provided by the motion control motor to the flow channel gear.

In a preferred embodiment of the invention, at least a part of said flow channel is provided in an angular form.

In a preferred embodiment of the invention, at least a part of said flow channel is provided in an inclined form.

Another preferred embodiment of the invention, comprises a cleaning surface that is positioned to be in contact with the outlet of said flow channel and provided to be coplanar with said outlet.

According to another preferred embodiment of the invention, said cleaning surface has been formed to close the outlet of the flow channel to the flow channel.

According to another preferred embodiment of the invention, said motion control motor and flow channel have been configured to allow the outlet of the flow channel to be in contact with the cleaning surface.

The present invention is a coffee machine that has been developed out in order to reach all of the aims that can be construed from the information above and the detailed description below, comprising a coffee grinder according to any of the claims 1-12, a water tank, at least a water outlet configured to feed the container in which the coffee particles that have been conveyed from the grinder and the water transferred from the water tank are collected, and a heating element that heats up the container in order to prepare the coffee.

A preferred embodiment of the invention comprises at least a secondary chamber in order to feed a secondary component to the inlet of said flow channel having a secondary chamber outlet.

A preferred embodiment of the invention comprises an intermediate channel located between said outlet and the flow channel, provided to rotate together with the flow channel, and an extension at the outer surface of the intermediate channel that comes in contact with the secondary chamber outlet during the rotation of the flow channel in order to clean the components remaining at the outlet area of the secondary chamber.

A preferred embodiment of the invention comprises at least two containers and it has been configured such that the motion control motor can move the flow channel outlet between said containers.

### BRIEF DESCRIPTION OF THE FIGURES

FIG. 1 is the illustrative isometric view of an embodiment of the coffee grinder subject to the invention.

FIG. 1.A is the rear view of the coffee grinder subject to the invention.

FIG. 1.B is the A section of FIG. 1.A.

FIG. 1.C shows the sequential view of the flow channel.

FIG. 1.D shows the isometric view of the drive element and the flow channel.

FIG. 1.E shows the exploded view of the structure of FIG. 1.C.

FIG. 1.F is the side view of another embodiment of the coffee grinder subject to the invention. In this embodiment the, flow channel opening cleaning element has been shown.

FIG. 1.G shows the isometric view of the drive element, flow channel and flow channel cleaning element.

FIG. 2 is the isometric view of the coffee grinder adapted to be used in a coffee preparation machine and the secondary component chamber.

FIG. 2.A shows the top view of the assembly shown in FIG. 2.

FIG. 2.B shows the C section of FIG. 2.A.

FIG. 2.C shows the isometric view of the secondary chamber outlet and the transfer channel configured to clean the outlet of the secondary chamber.

### DESCRIPTION OF THE REFERENCE NUMBERS SHOWN IN THE FIGURES

10. Chamber
11. Chamber inlet
12. Secondary chamber
121. Secondary chamber inlet
122. Secondary chamber outlet
20. Grinding mechanism
21. Drive element
211. Shaft
212. Blade
22. Blade cover
23. Grinder outlet
24. Carrier
241. Carrier drive element
242. Gear
30. Flow channel
31. Inlet
32. Outlet
33. Flow motion gear
331. Gasket
40. Motion control motor
41. Transfer gear
42. Drive element carrier plate
43. Flow channel carrier plate
431. Connection wall
50. Intermediate channel
51. Extension
52. Opening
60. Outlet cleaner
61. Cleaning surface
62. Cleaner carrier
K. Transfer element
X. Channel inlet axis
R. Radial direction
M. Housing
V. Screw

### DETAILED DESCRIPTION OF THE INVENTION

In this detailed description, the coffee grinding device subject to the invention and the coffee machine containing said device, has been described with illustrative examples without limiting the scope of the invention, only in order to provide a better understanding of the subject matter.

The invention is related to a particle carrier system that prevents the immobility or sticking of the particles onto the surface over which they are being carried and a Turkish coffee preparation device provided with said coffee grinder.

The invention is basically a coffee grinder, comprising a coffee grinding mechanism (20) having at least a grinder outlet (23) provided in order to grind coffee, at least a flow channel (30) that directs the ground coffee particles conveyed from the outlet (23) of the grinder in order to transfer them to a container (M), and its inlet (31) positioned such that right below the grinder outlet (23) and connected to the grinder such that it can rotate according to the channel inlet axis (X) that passes through the center of said inlet, and a motion control motor (40) that successively moves said flow channel (30) at the inlet axis (X) in opposite radial directions (R) in a suitable amount and frequency in order to prevent the sticking of the ground coffee particles located in the flow channel (30), to said flow channel (30).

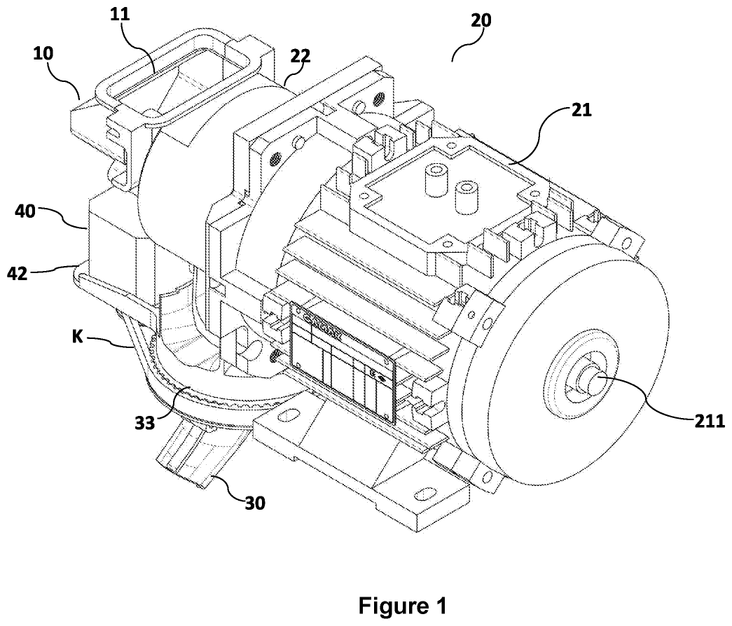

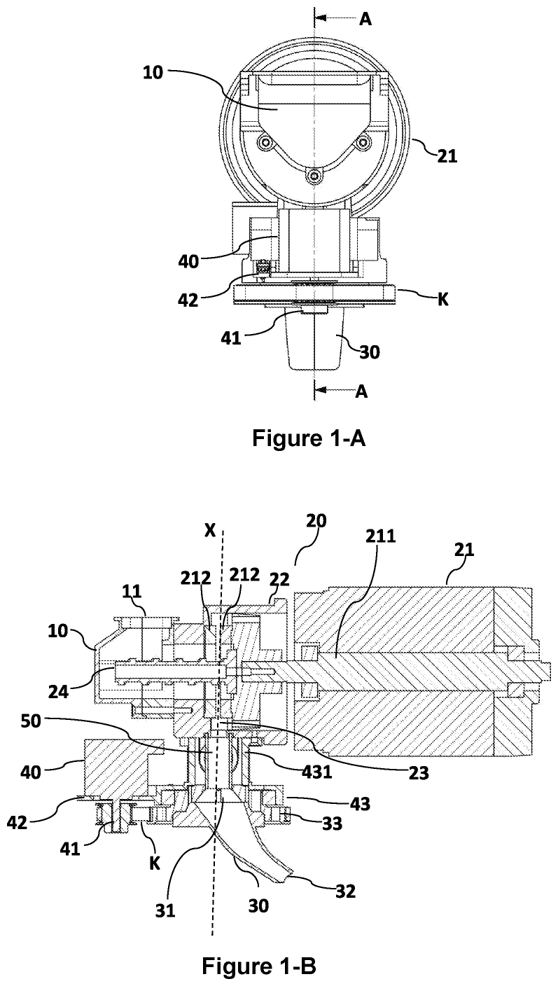

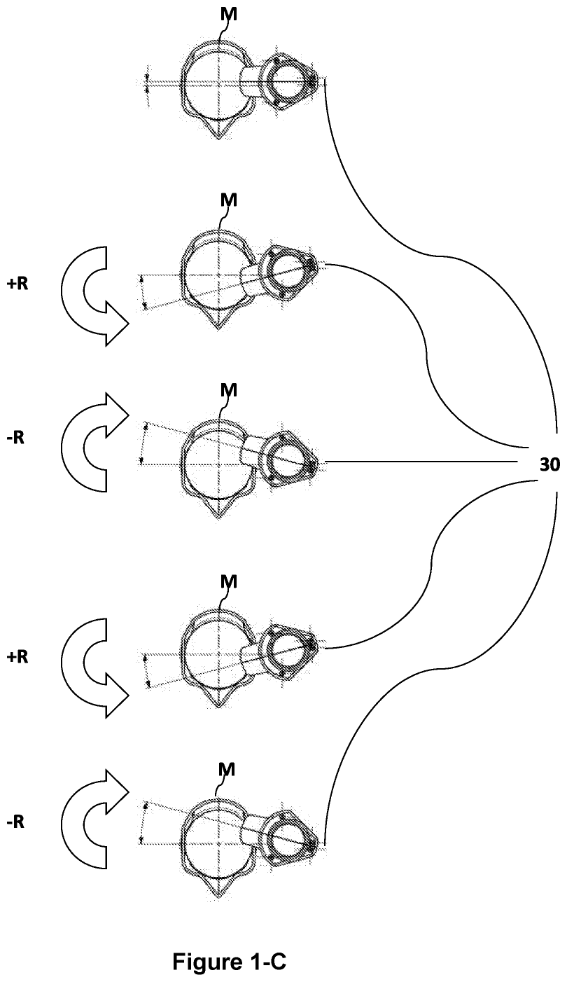

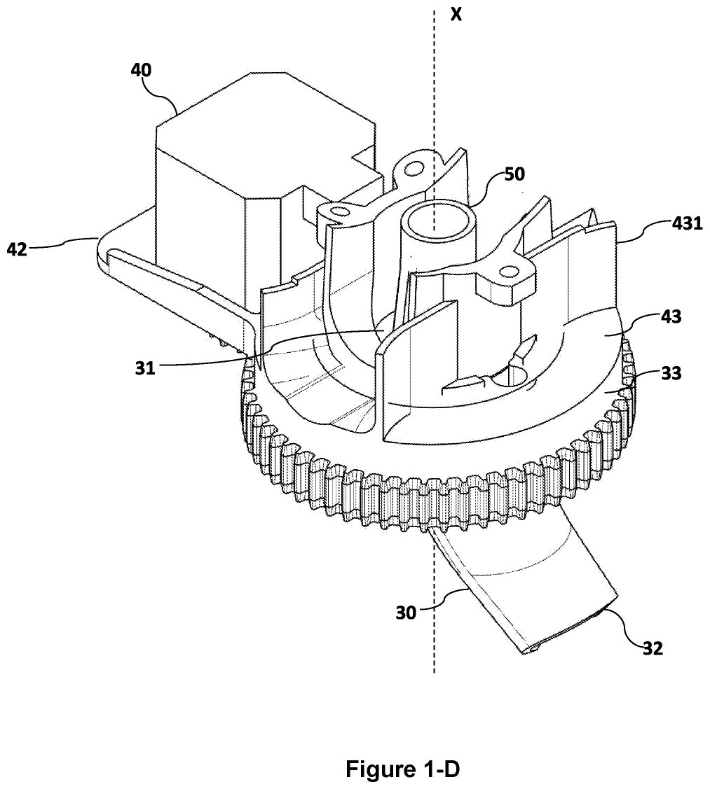

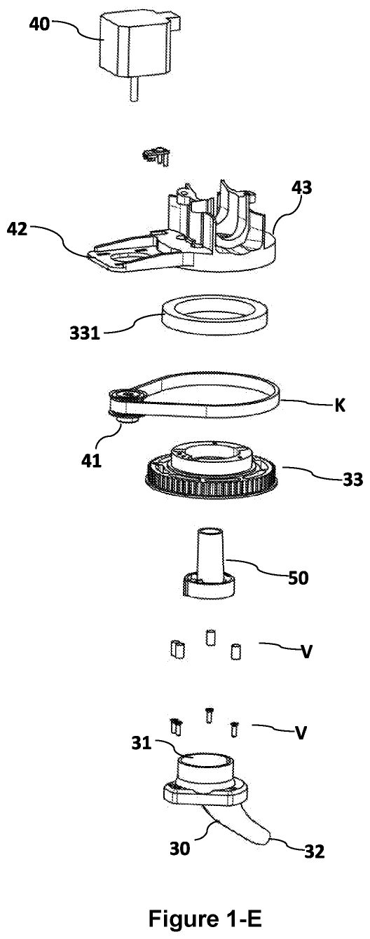

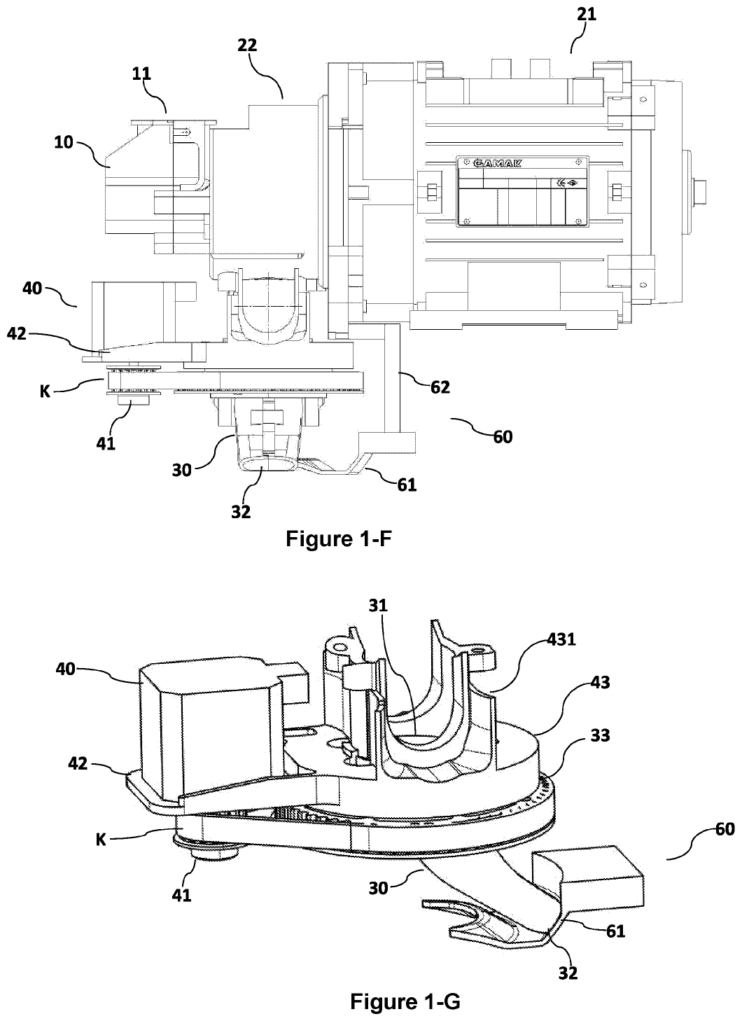

FIG. 1.A is the rear view of the coffee grinder and FIG. 1.A is the rear view thereof. The coffee grinder comprises a chamber into which the coffee beans shall be added. The coffee beans are provided from the chamber inlet (11). Another larger chamber (10) is connected to the inlet (11) of the first chamber. The chamber (10) is connected to a grinder mechanism. The coffee particles that are transferred into the chamber (10) are brought to the desired size by being ground in said grinder mechanism (20).

As can be seen in the section shown in FIG. 1.B, a carrier (24) has been provided inside the chamber (10) to carry the coffee beans towards the blades (212) that will be grinding the coffee beans.

The carrier (24) is provided as a threaded form. The shaft with threads thereon is driven by means of a drive element (21) that drives the blades (212) at the same time. As has already been mentioned before, the coffee beans are ground by a pair of blades (212). The blades (212) are preferably in circular form and are connected to a shaft (211) that is driven rotationally by the drive element (21). The distance between the blades (212) has been arranged so that they do not exceed 150 μm in order to provide suitable coffee particles. The blades (212) are surrounded by a blade cover (22).

A grinder outlet (23) has been provided at the bottom section of said blades (212) such that the ground coffee particles are discharged therein. A flow channel (30) has been provided beneath the grinder outlet (23) that is connected to the grinder outlet via an intermediate channel (50). The flow channel (30) can also be directly connected to the grinder outlet (23). Openings (52) have been formed around the intermediate channel (50) in order to ensure that the delivery of the coffee particles to the flow channel (30) is not restricted. The intermediate channel (50) has been provided such that it can rotate at the same axis together with the flow channel (30).

The flow channel (30) comprises an inlet (31) and an outlet (32) and by virtue of these, the channel suitably directs the coffee particles that have been provided at the grinder outlet (23). The flow channel (30) has been connected to the coffee grinder such that it can rotate according to a channel inlet axis (X) extending from the center of the inlet (31).

The flow channel (30) can be provided as an inclined and/or angular form in order to ensure that the coffee particles can easily flow.

The mentioned flow channel (30) is rotated bi-directionally at a certain distance around the channel inlet axis (X) by means of the motion control motor (40). Said motion has been shown in FIG. 1.C. The drive element (40) moves the flow channel (30) in a radial direction (+R) and following this, it comes back to the starting point and rotates the channel in the opposite direction (−R) of the initial radial direction (+R). The motion at the radial direction (±R) oscillates the flow channel (30) and prevents the sticking of the coffee particles. Preferably the radial movement (±R) in both directions is equal. In an embodiment, said movement amount is equivalent to ±5°.

The motion control motor (40) is a motor that can provide motion in both radial directions (R) in a controlled manner. The motor is preferably a servo motor. Alternatively, DC motors with encoder or stepper motors can also be selected as a motion control motor (40). The movement speed, acceleration and distance of the motion control motor (40) in the radial direction (R) can be adjusted. The coffee flow amount and speed, provided from the flow channel (30) can be adjusted using said variables.

A preferred embodiment of the invention comprises a control unit (not shown in the figures) in order to control at least one of the factors such as movement speed, frequency, acceleration and motion distance of said motion control motor (40). Accordingly, the necessary motion values in order to prevent the sticking of coffee particles can be applied according to the situation at hand. For example, said flow channel (30) will be able to be moved at a slower speed and frequency in said radial direction (R) for coffee types having larger particles than Turkish coffee.

Besides this, in the case that the grinder system comprises more one than one container (M) said control unit can control the motion control motor (40) which moves the flow channel (30) outlets (32) between said containers (M).

Moreover, because of said control, the control unit, is able to move the outlet (32) of flow channel (30) such that it comes into contact with the cleaning surface (61), which is to be described later on, or such that the cleaning surface (61) completely closes off the outlet of the flow channel.

A preferred embodiment of the invention comprises an input unit (not shown in the figures) in order to determine at least one of the factors such as movement speed, frequency, acceleration and motion distance of said motion control motor (40). Accordingly, the user is able to determine the related inputs.

The motion control motor (40) is not only able to provide motion to the flow channel directly, in the radial direction (R) under said conditions, but it may also provide motion via the flow motion gear (33), as shown in FIG. 1.D.

FIG. 1.E shows the exploded view of the structure of FIG. 1.D. In this embodiment, said flow channel (30), is fixed to a flow motion gear (33) via the screws (V). The flow motion gear (33) is coupled to a flow channel carrier plate (43) by placing a gasket (331) thereon. Said coupling has been provided such that it does not restrict the rotation of the flow motion gear (33). Two openings have been formed at the hubs of the flow channel carrier plate (43) and the flow motion gear (33) in order to keep the grinder outlet (23) and the flow channel (30) relation open.

A drive element has been provided to the flow channel carrier plate (43) to be monolithic with the carrier plate (42). The drive element (40) has been positioned at the drive element carrier plate (42). A transfer gear (41) has been coupled to the drive element (40) shaft. The transfer gear (41) and the flow motion gear (33) have been connected to each other by means of a transfer element (K). The transfer element (K) can be selected as a gear belt.

The coffee grinder can comprise an outlet cleaner (60). Said structure has been shown in FIGS. 1.F and 1.G. The position in which the sticking of the coffee particles inside the flow channel is prevented is shown in FIG. 1.F and the position where the outlet cleaner (60) cleans the outlet (32) of the flow channel (30) has been illustrated in FIG. 1.G. The outlet cleaner (60), comprises at least a cleaning surface (61). The cleaning surface (61) is a fixed structure that is provided coplanar with the outlet (32).

The mentioned flow channel (30) is rotated around the channel inlet axis (X) by means of the motion control motor (40). The rotation motion is provided at a limited angle when they are provided to prevent the sticking of coffee particles. The cleaning surface (61) has been positioned such as to contact the outlet (32) of the flow channel (30) when it deviates from said limited angle. During contact, the accumulation formed at the outlet (32), for example, coffee particles or water droplets when coffee preparation process is being carried out, are removed by the cleaning surface (61).

The grinder subject to the invention can be used in a coffee preparation machine.

The coffee machine basically comprises a coffee grinder according to any of the claims 1-6, a water tank (not shown in the figures) and at least a water outlet configured to feed the container (M) in which the coffee particles that have been conveyed from the grinder and the water transferred from the water tank (not shown in the figures) are collected.

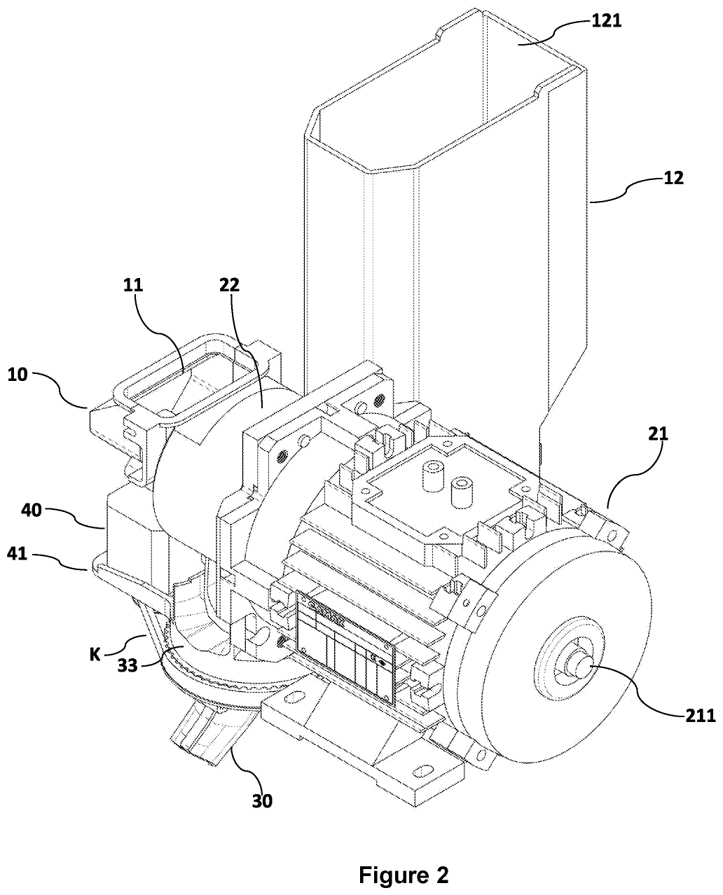

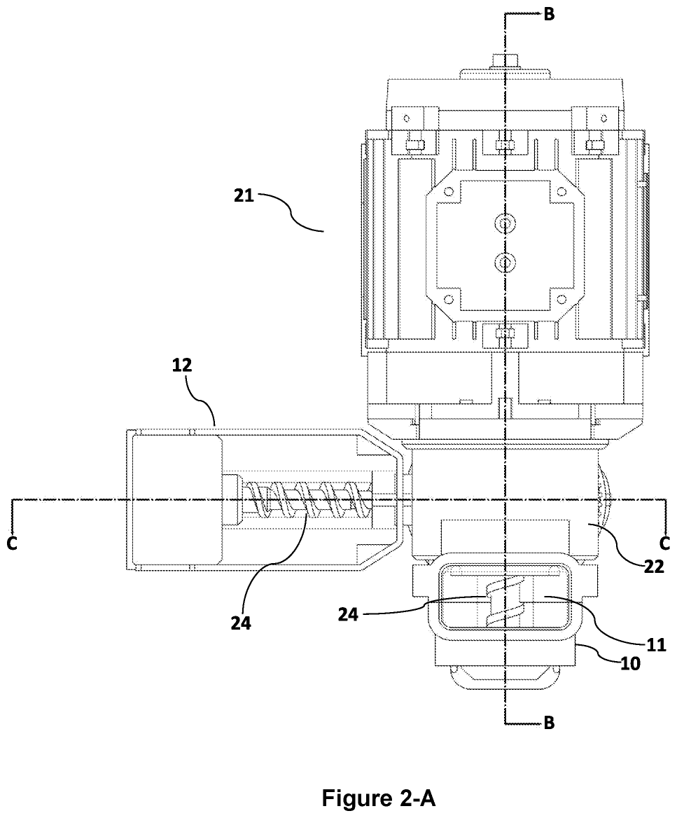

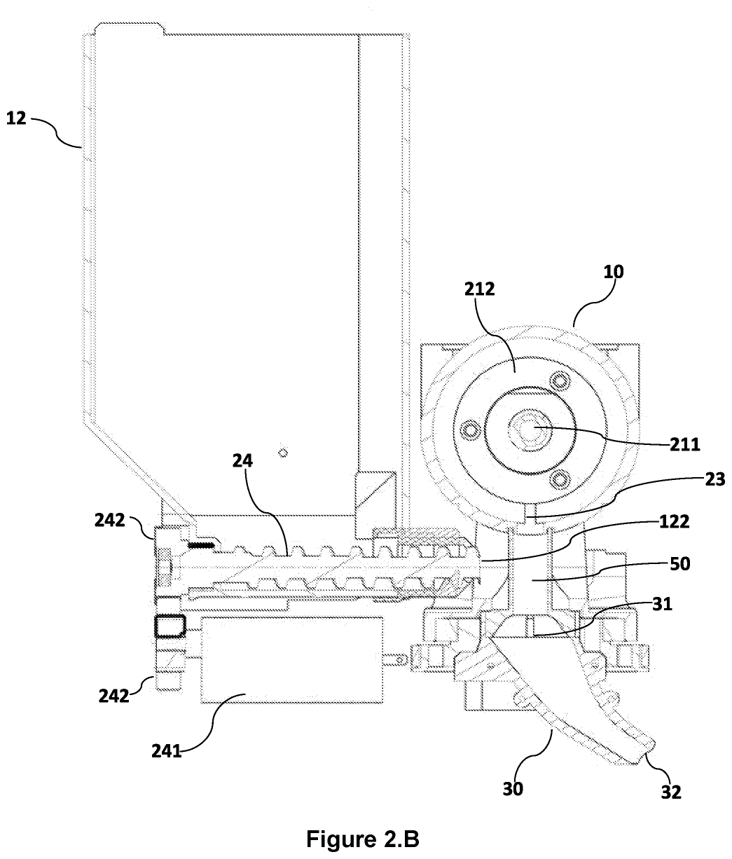

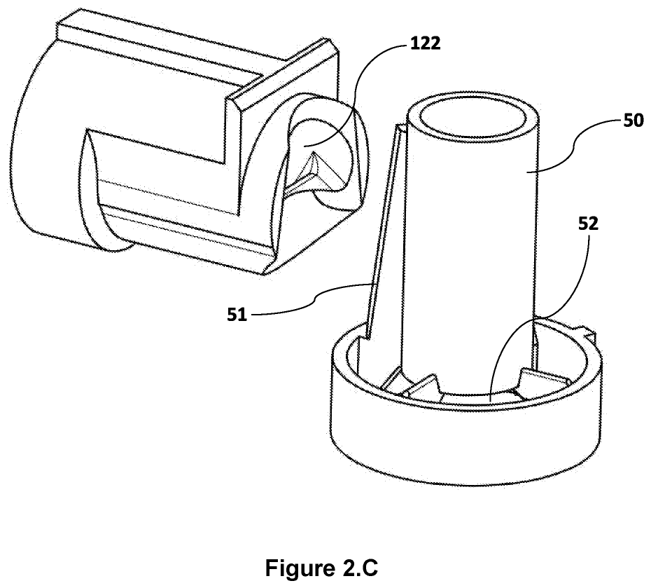

In FIG. 2, an isometric view of a section of the coffee machine has been shown and in FIG. 2.B, shows a section view according to the C axis in FIG. 2.A. The section according to B axis has not been illustrated as it shall correlate with FIG. 1.B.

In FIG. 2, the coffee machine comprises a secondary chamber (12) besides the coffee grinder described above. The secondary chamber (12) enables the addition of secondary inputs to the coffee. The secondary chamber (12) has been provided to transfer the secondary inputs towards the secondary chamber inlet (121) and the flow channel (30) inlet.

In FIG. 2.B, the secondary chamber (12) comprises a carrier (24) therein. The carrier (24) can have a threaded shaft form. The threaded shaft carries the secondary input provided to the secondary chamber (12) by rotating around its own axis. Said motion is carried out by means of a carrier drive element (241).

The carrier drive element (241) shaft is coupled to a gear and the threaded shaft is coupled to another gear. Both the gears that have been mentioned come into contact with each other to perform power transfer. The rotation provided by means of the carrier drive element (241) is transferred to the threaded shaft by means of said gears (242).

An intermediate channel (50) can be provided between the grinder outlet (23) and the flow channel (30). Openings (52) have been formed around the intermediate channel (50) in order to ensure that the delivery of the coffee particles to the flow channel (30) is not restricted. The intermediate channel (50) has been provided such that it can rotate at the same axis together with the flow channel (30).

In FIG. 2.C, an extension (51) is provided at the outer surface of the intermediate channel (50). The extension (51) has been provided such that it shall contact the secondary chamber outlet (122), via the rotation motion of the intermediate channel (50). Accordingly, the accumulation of the inputs at the secondary chamber outlet (122) is cleaned and is transferred towards the flow channel (30).

The water tank mentioned beforehand may comprise a heating element in order to heat the water therein. Said heating element can be selected as a resistor.

Besides this, the coffee machine subject to the invention can comprise an internal container (M). The container (M) is positioned such that the coffee particles and the secondary inputs provided from the secondary chamber (12) are discharged via the flow channel (30) into said container. Following this, the water that is heated via the heating element in the water tank is discharged into the container (M) and therefore coffee can be prepared.

In another embodiment, the container (M) can comprise a heating element, preferably a resistor. After the inputs provided from the flow channel (30) and the water tank are transferred into the container (M), the heating element carries out the heating process and coffee is prepared.

After a sufficient amount of coffee is transferred into the container (M), the flow channel (30) returns back to its park position. The cleaning surface (61) that has been mentioned before is positioned and formed such that it can seal off the flow channel (30) opening. The entrance of humidity and steam into the flow channel (30) during the coffee preparation process is prevented following the closing of the flow channel (30) opening.

Moreover, the container (M) can contain a scale system. Therefore it can be controlled if suitable amounts of inputs have been transferred into the container (M) or not. In this embodiment not only, a secondary container (M) can be provided in order to prepare coffee and but also coffee can be prepared in the container comprising a scale system.

The protection scope of the invention has been defined in the claims attached and it shall not be limited to the embodiments disclosed for illustration purposes in the description. It is obvious that a person skilled in the art can carry out similar embodiments within the light of the information provided above without deviating from the main theme of the invention.

1. A coffee grinder that is used for grinding coffee, comprising a grinding mechanism having at least a grinder outlet, characterized by comprising:
at least one flow channel that directs ground coffee particles conveyed from the outlet of the grinder in order to transfer them to a container, and its inlet positioned such that right below the grinder outlet and connected to the grinder such that it can rotate according to a channel inlet axis that passes through the center of said inlet; and
a motion control motor that successively moves said at least one flow channel at the inlet axis in opposite radial directions in a suitable amount and frequency in order to prevent the sticking of the ground coffee particles located in the flow channel, to said flow channel.

2. A coffee grinder according to claim 1, comprising a control unit in order to control at least one of the factors such as movement speed, frequency, acceleration and motion distance of said motion control motor.

3. A coffee grinder according to claim 2, comprising an input unit in order to control the amount of at least one of the factors such as movement speed, frequency, acceleration and motion distance of said motion control motor.

4. A coffee grinder according to claim 1, wherein the motion control motor is a servo motor.

5. A coffee grinder according to claim 1, wherein the motion control motor is a stepper motor.

6. A coffee grinder according to claim 1, wherein the motion control motor is a DC motor with an encoder.

7. A coffee grinder according to claim 1, comprising:
a flow channel gear provided to rotate according to the inlet axis, such that it is fixedly connected to the flow channel, and a transfer element that transfers the rotation motion provided by the motion control motor to the flow channel gear.

8. A coffee grinder according to claim 1, wherein at least a part of said flow channel is provided in an angular form.

9. A coffee grinder according to claim 1, wherein at least a part of said flow channel is provided in an inclined form.

10. A coffee grinder according to claim 1, comprising a cleaning surface that is positioned to be in contact with the outlet of said flow channel and provided to be coplanar with said outlet.

11. A coffee grinder according to claim 1, wherein the cleaning surface is formed to close the outlet of the flow channel from the outside to a flow channel.

12. A coffee grinder according to claim 10, wherein said motion control motor and flow channel are configured such that they allow the outlet of the flow channel to come into contact with the cleaning surface.

13. A coffee machine; comprising a coffee grinder according to claim 1, a water tank, at least a water outlet configured to feed the container in which the coffee particles that have been conveyed from the grinder and the water transferred from the water tank are collected, and a heating element that heats up the container in order to prepare the coffee.

14. A coffee machine according to claim 13, comprising at least a secondary chamber in order to feed a secondary component to the inlet of said flow channel having a secondary chamber outlet.

15. A coffee machine according to claim 13, comprising an intermediate channel located between said grinder outlet and the flow channel, that are provided to rotate together with the flow channel, and an extension at the outer surface of the intermediate channel that comes in contact with the secondary chamber outlet during the rotation of the flow channel in order to clean the components remaining at the outlet area of the secondary chamber.

16. A coffee machine according to claim 13, comprising at least two containers and it has been configured such that the motion control motor can move the flow channel outlet between said containers.

17. A coffee grinder according to claim 11, wherein said motion control motor and flow channel are configured such that they allow the outlet of the flow channel to come into contact with the cleaning surface.
